(19) United States
(12) Patent Application Publication
(10) Pub. No.: US 2014/0036262 A1
(43) Pub. Date: Feb. 6, 2014

(54) ELECTRONIC AND PLASMONIC ENHANCEMENT FOR SURFACE ENHANCED RAMAN SPECTROSCOPY

(71) Applicants: Shih-Yuan Wang, Palo Alto, CA (US); Gary Gibson, Palo Alto, CA (US); Zhiyong Li, Foster City, CA (US); Alexandre M. Bratkovski, Mountain View, CA (US); Huei Pei Kuo, Cupertino, CA (US); Zhang-Lin Zhou, Palo Alto, CA (US); R Stanley Williams, Portola Valley, CA (US)

(72) Inventors: Shih-Yuan Wang, Palo Alto, CA (US); Gary Gibson, Palo Alto, CA (US); Zhiyong Li, Foster City, CA (US); Alexandre M. Bratkovski, Mountain View, CA (US); Huei Pei Kuo, Cupertino, CA (US); Zhang-Lin Zhou, Palo Alto, CA (US); R Stanley Williams, Portola Valley, CA (US)

(21) Appl. No.: 13/562,567

(22) Filed: Jul. 31, 2012

(51) Int. Cl. G01J 3/44

(52) U.S. Cl. 356/301

(57) ABSTRACT

An apparatus for surface enhanced Raman spectroscopy includes a substrate, a nanostructure and a plasmonic material. The nanostructure and the plasmonic material are integrated together to provide electronic and plasmonic enhancement to a Raman signal produced by electromagnetic radiation scattering from an analyte.

### BACKGROUND

Raman spectroscopy is used to study the transitions between molecular energy states when incident photons scatter as a result of their interaction with an analyte (i.e., a species, molecule or, in general, matter being analyzed). The scattered photons have an energy that is shifted in frequency due to two processes: the incident photons excite the analyte to cause the analyte to transition from a certain initial energy state to another (either virtual or real) energy state; and the excited analyte radiates as a dipole source to produce a scattered signal. The analyte radiates under the influence of its environment at a frequency that may be relatively low (called Stokes scattering), or relatively high (called anti-Stokes scattering), as compared to the frequency of the excitation photons.

The Raman spectra of a given analyte have characteristic peaks corresponding to the Raman-active vibrational modes (including bending, stretching, twisting modes), which may be used to identify the analyte. As such, Raman spectroscopy is a useful technique for a variety of chemical or biological sensing applications. However, the intrinsic Raman scattering process is often relatively inefficient. For purposes of improving the efficiency of the above-described excitation and radiation processes, enhancements may be made using surface enhanced Raman spectroscopy (SERS). These enhancements typically include rough metal surfaces, metal nanoparticles various types of nano-antennas, nanostructures such as nanowires coated with metal, black silicon coated with metal, as well as waveguiding structures.

### BRIEF DESCRIPTION OF THE DRAWINGS

FIG. 1 is a semi-schematic perspective view of a surface enhanced Raman spectroscopy (SERS) sensor according to an example implementation.

FIGS. 2 and 3 are cross-sectional views of quantum dot structures of a SERS sensor according to example implementations.

FIG. 4 is a cross-sectional view of a nanowire structure of an SERS sensor according to an example implementation.

FIG. 5 is a flow diagram depicting a technique to electronically and plasmonically enhance Raman signals according to an example implementation.

FIG. 6 is a semi-schematic perspective view of a nanowire structure of an SERS sensor having a Bragg mirror-based resonator according to an example implementation.

FIG. 7 is a cross sectional view of a quantum dot structure of an SERS sensor having a Bragg mirror-based resonator according to an example implementation.

FIG. 8 is a flow diagram depicting a technique to construct an SERS sensor to enhance a Raman spectra bandwidth according to an example implementation.

### DETAILED DESCRIPTION

Techniques and systems are disclosed herein for purposes of both electronically and plasmonically enhancing a Raman signal that is produced by the Raman scattering of incident photon energy (herein called a “pump signal”) by a target sample (i.e., a species, molecule(s) or, in general, matter being analyzed and herein called an “analyte”). More specifically, in accordance with example implementations that are disclosed herein, a surface enhanced Raman spectroscopy (SERS) sensor has an integrated structure that contains a plasmonically enhancing material and an electronically enhancing material.

The electronically enhancing material may be a semiconductor or any other material that may be optically excited (such as an organic dye, rhodamine 6G, in a polymer host material, such as polyimide, for example) such that the material may be optically pumped to an upper excited state by radiation, and when the excited state relaxes to a lower state, such as the ground state, energy is transferred from the material to the analyte. The electronically enhancing material may be disposed below or above the plasmonically enhancing material of the integrated structure, depending on the particular implementation.

The plasmonically enhancing material may be any material that gives rise to surface plasmons that enhance the electric field surrounding the material when the analyte is placed in proximity (within 10 nanometers (nm), for example) of the material. For specific examples that are disclosed herein, the plasmonically enhancing material may be a metal, such as palladium, platinum, aluminum, copper, gold, silver or nickel, or a combination of two or more of these metals. Other plasmonically enhancing materials (other metals and dielectric materials, for example) may be used, in further implementations.

For the specific examples that are disclosed herein, the plasmonically enhancing material partially or completely overlays (or underlays) the electronically enhancing material, such as example implementations disclosed herein in which a partial coverage and/or semitransparent plasmonically enhancing metal is disposed on an electronically enhancing material. However, in further implementations, the electronically enhancing material may be disposed on the plasmonically enhancing material. In an example implementation, the plasmonically enhancing material may be a plasmonic metal, such as gold; and the electronically enhancing material may be an organic dye, such as rhodamine 6G, which is disposed on top of the gold in a polymer host, such as polymide.

In this context, “on a structure” or “on a material” means at least partially supported by the structure/material, which may or may not involve contact with the structure/material. For example, a plasmonically enhancing material that is disposed on an electronically enhancing material may or may not contact the electronically enhancing material (i.e., no, one or multiple intervening layers may be disposed between the materials, for example), depending on the particular implementation.

For example implementations described herein, the electronically enhancing material is formed from an underlying structure, and the plasmonically enhancing material is semi-transparent and/or partially covers the electronically enhancing structure. In this regard, the plasmonically enhancing material is sufficiently thin or patterned to allow communication through the plasmonically enhancing material in the frequencies of interest, such as the frequencies of the spectra associated with the incident pump signal (635, 785, 850, 980, 1300 or 1550 nanometers (nm), to name a few possible pump wavelengths) and the Raman signal (typically with Raman shifts of 100 to 3000 centimeters (cm)⁻¹). As a more specific example, in accordance with some implementations, the plasmonically enhancing material may have a thickness of less than or equal to 100 nm, although the plasmonically enhancing material may have a thickness greater than 100 nm. For example, in some implementations, a relatively thicker plasmonically enhancing material may be employed, which has openings (a “mesh” or random islands, for example), such that the partial coverage of the plasmonically enhancing material allows communication of the frequencies of interest through the openings. The plasmonically enhancing material may be formed by a layer fabrication process suitable for forming a relative thin layer, such as a process that involves atomic layer deposition (ALD), sputtering, angle evaporation, for example.

In accordance with example implementations, the electronically enhancing material is part of a nanostructure. In general, “nanostructure” refers to a structure that has at least one dimension that is on the nano-scale (from 1 nm to 1000 nm, for example). The nanostructure may, in general, be a semiconductor, such as a Group II-VI semiconductor (i.e., a semiconductor formed from an element selected from Group II of the periodic table and an element selected from Group VI of the periodic table) or a Group III-V semiconductor (i.e., a semiconductor formed from an element selected from Group III of the periodic table and an element selected from Group V of the periodic table). The nanostructure may be formed from other materials, in accordance with other implementations.

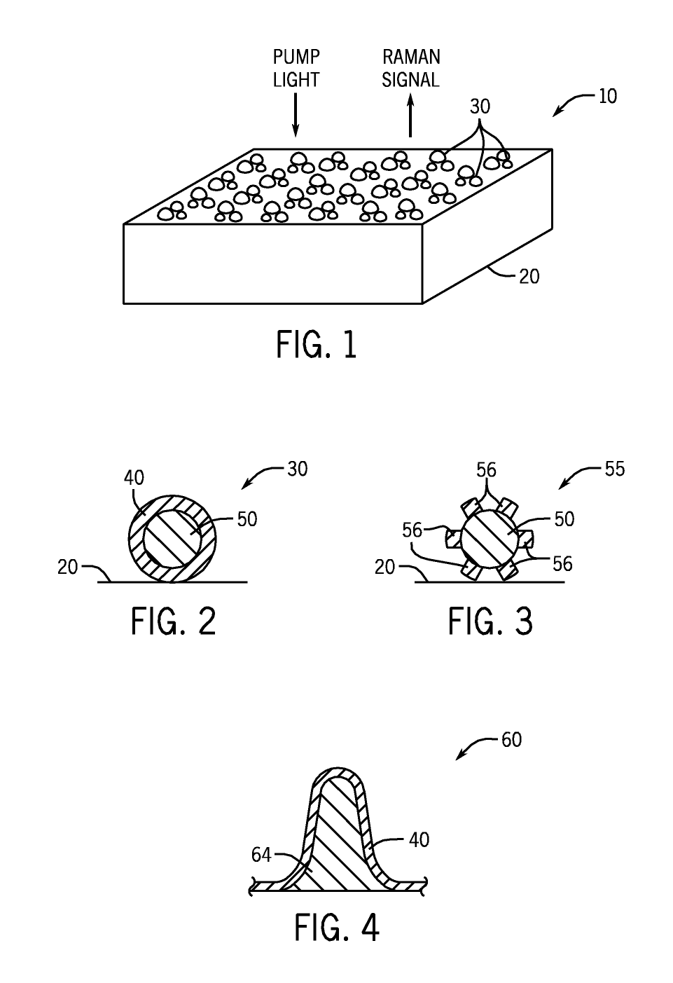

FIG. 1 depicts an exemplary implementation of a surface enhanced Raman spectroscopy (SERS) sensor 10. It is noted that FIG. 1 is a simplified view directed to a region of the sensor 10 in which scattering and Raman signal enhancement occur. The sensor 10 may have various features, other than those disclosed herein, such as, for example, features directed to guiding the pump signal to the region. For example, the substrate may serve as a waveguide and/or the sensor may have a slab or two dimensional features to guide or partially guide the pump light with a large evanescent field intersecting the nanostructures to optically interact with nanostructures/SERS sensors. The waveguide can also have Bragg mirrors or reflectors to increase the interaction time/length of the pump with the nanostructures/SERS sensors. The sensor may also have features further enhancing the Raman scattering processes and enhancing the collection of energy produced as a result of those scattering processes. Thus, as examples, the sensor 10 may have various other surface enhancements, waveguide structures, collection enhancement mirrors, which are not shown, in accordance with further implementations.

For the example that is depicted in FIG. 1, the sensor 10 contains an integrated structure that is formed from an electronically enhancing nanostructure and a plasmonically enhancing metal; and the integrated structure is disposed on a base substrate 20. The base substrate 20 may be transparent or non-transparent. As examples, the base substrate 20 may be formed from such materials as insulators (e.g., glass, quartz, ceramic, alumina, silica, silicon nitride, etc.) and/or polymeric material(s) (polycarbonate, polyamide and/or acrylics, for example).

In accordance with example implementations, a spatially repeated or randomly distributed structure is integrated with the base substrate 20 and includes an underlying electronically enhancing nanostructure and a plasmonically enhancing metal is disposed on the nanostructure. The nanostructure may, in general, may be a semiconductor material, such as a material selected from the Group II-V family of elements or the Group III-V family of elements in the form of quantum dots or nanowires, in accordance with example implementations.

In accordance with an example implementation, the nanostructure is a quantum dot structure 30. As depicted in FIG. 1, the quantum dot structures 30 may be spatially distributed orderly or randomly in groups of two or more nanostructures across the surface of the base substrate 20. For the example of FIG. 1, the quantum dot structures 30 are arranged in groups of three with separation of less than 10 nm from adjacent surfaces, where each quantum dot structure 30 has a different size (diameter, for example). However, the size of the group may be greater than or less than three, in accordance with other implementations. In some implementations, the quantum dots/structures 30 may all have approximately the same size.

Referring also to FIG. 2, which depicts a cross section of an exemplary quantum dot structure 30, the structure 30 for this example includes a semi-transparent plasmonic metal layer 40 that is disposed on an underlying quantum dot 50 that is formed from, for example, a semiconductor material. In general, the quantum dot 50 has a sufficiently small size, which permits the energy inside the quantum dot 50 to be different than the bulk energy level of the substrate 20. In other words, the quantum dot 50 allows for quantum confinement of a corresponding quantum energy level.

To form the quantum dots 50, a Group III-V or Group II-VI semiconductor (as examples) may be grown epitaxially, or synthesized separately and spun onto the base substrate 20 in a resist-type material (non-limiting examples of which include polyamide, a spin-on glass, photoresists, or the like). As a more specific example, the quantum dot 50 may be formed from a semiconductor such as GaN, InGaN, AlGaN, GaAs, AlGaAs, InP, InGaAs, InAlAs, InGaAsP, in which interband transition occurs. In other implementations, the quantum dot 50 may be formed from a semiconductor structure, such as an InGaAs/InAlAs semiconductor structure, in which quantum cascade intraband transition occurs. Thus, many variations are contemplated, which are within the scope of the appended claims.

The metal layer 40 is a semi-transparent layer, in accordance with example implementations, which means that the metal layer 40 has a thickness T (a thickness T less than 100 nanometers, for example) that is thin enough to allow the spectra of the Raman and pump signals to pass through the layer 40 or greater than 100 nm in case of partial metal coverage.

In accordance with some implementations, the metal layer 40 may be deposited using atomic layer deposition (ALD), (sputtering, angle evaporation), and the ALD may be used to deposit the metal layer as a single metal layer across all of the quantum dots 50 of the sensor 10, as depicted in FIG. 1. However, referring to FIG. 3, in accordance with further implementations, the ALD may be used to form islands 56 of metal to partially cover the quantum dots to form quantum dot structures 55. It is noted that the thickness of the island 56 may be consistent with the thickness of an otherwise semitransparent or opaque layer. Thus, communication for the frequencies of interest occurs due to the partial coverage and/or semitransparency of the metal.

SERS sensors in accordance with further implementations may include nanostructures other than quantum dots for purposes of electronically enhancing the Raman signal. For example, referring to FIG. 4 in conjunction with FIG. 1, in accordance with further implementations, the nanostructures may be nanowires 64 (to form corresponding nanowire structures 60 with the metal layer 40). The nanowires 64 may be formed from one of the semiconductors or semiconductor structures disclosed above for the quantum dots 50, in accordance with some implementations. The nanowires can be grown epitaxially such as vapor-liquid-solid (VLS) with or without a metal catalyst using metal organic vapor phase epitaxy, or molecular beam epitaxy or grown in a solution. A combination of nanowires and quantum dots is also possible for the nanostructured SERS sensors to further increase the energy spectrum of the nanostructured/SERS sensor to approximately match the Raman spectrum, which is approximately 100-300 nm wide, of the analyte.

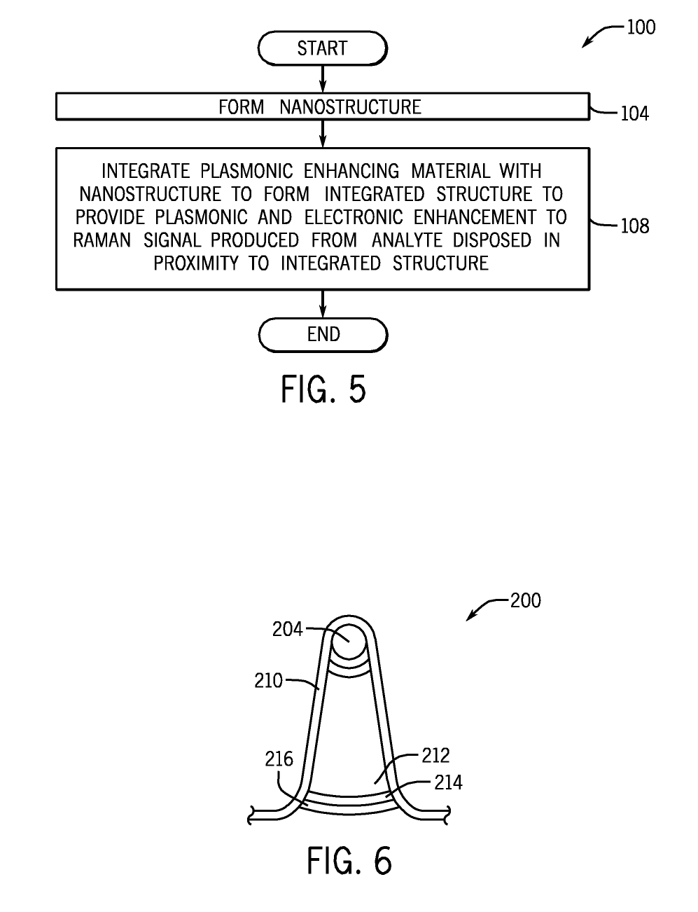

Thus, referring to FIG. 5, in accordance with example implementations, a technique 100 to enhance a Raman signal includes forming (block 104) a nanostructure (one of multiple nanostructures, for example) on a substrate. Pursuant to block 108, the technique 100 includes integrating a plasmonically enhancing material with the nanostructure to form an integrated structure to provide plasmonic and electronic enhancement to a Raman signal that is produced by electromagnetic radiation scattering from an analyte disposed in proximity to the integrated structure.

Other variations are contemplated, which are within the scope of the appended claims. For example, in accordance with further implementations, the quantum dot structure 30 or nanowire structure 60 may include an integrated resonator to increase the optical gain in the quantum dot or semiconducting nanowires to allow energy transfer from the semiconductor to the analyte, energy transfer from the semiconductor to the plasmon and/or enhancement of the Raman emission process. In general, the resonator improves the Q, or the optical intensity, in the quantum dots or nanowires, which increases the optical gain of the material. For example, as depicted in FIG. 6, a nanowire structure 200 includes an underlying nanowire 204 and a resonator, which, for this example, is a Bragg mirror that is formed on the nanowire 204.

The Bragg mirror includes overlapping layers, such as overlapping layers 212, 214 and 216 (depicted as examples in FIG. 6), which are selected from materials that cause the Bragg mirror to reflect a given wavelength band to establish a resonance band (i.e., a band corresponding to the pump wavelength) for the mirror. In this manner, the materials are selected so that their refractive indices cause the reflected light waves from the materials 212, 214 and 216 to constructively interfere to establish the resonance band of the mirror. The resonance band of the Bragg mirror, in accordance with example implementations, coincides with or is near the electronic resonance band of the underlying nanostructure. It is noted that although FIG. 6 depicts three layers 212, 214 and 216, the Bragg mirror may be formed from fewer than or greater than three layers, in further implementations.

Depending on the particular implementation, the layers 212, 214 and 216 may be, as examples, dielectric layers, silicon nitride layers and/or silver layers. The layers 212, 214 and 216 may be epitaxially deposited (by atomic layer deposition (ALD), for example) for purposes of conforming to the underlying nanostructure, such as the nanowire 204. As depicted in FIG. 6, a plasmonic metal layer 210 may be deposited on the Bragg mirror for purposes of plasmonically enhancing the Raman signal, as described above.

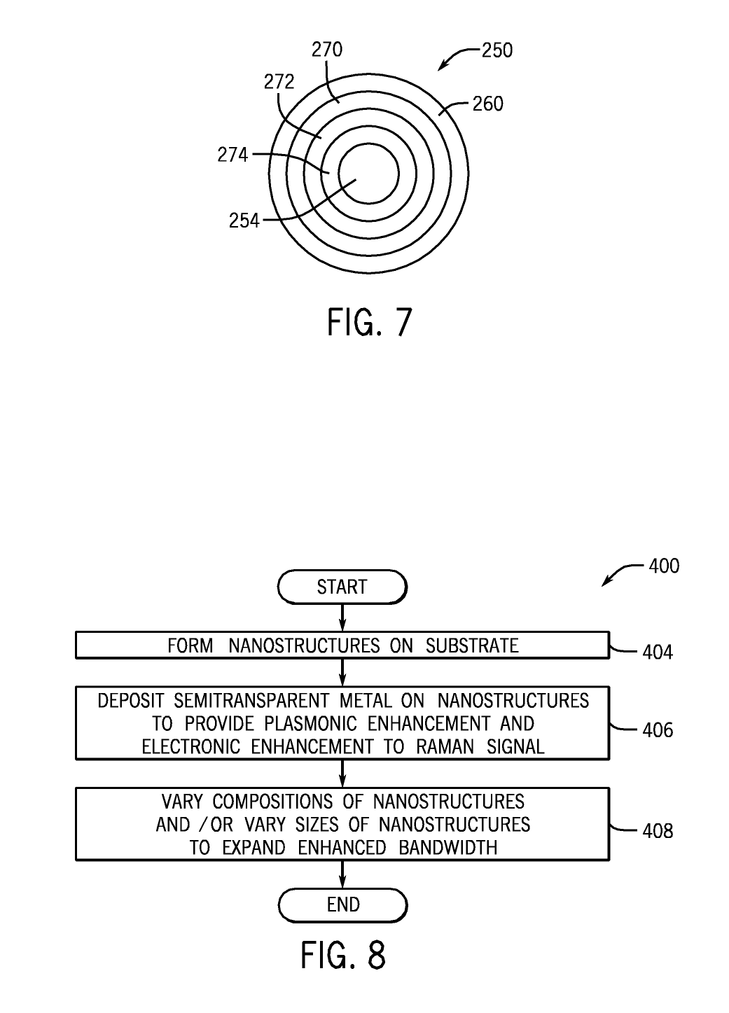

Bragg mirrors may be formed on nanostructures other than quantum dots, in accordance with further implementations. For example, FIG. 7 depicts a further implementation in which a quantum dot structure 250 includes a quantum dot 254 upon which are disposed various materials 270, 272 and 274 having refractive indices selected to form a Bragg mirror between the quantum dot 254 and outer semi-transparent metal layer 260 for the desired band.

A resonator other than a Bragg mirror-based resonator may be used in a SERS sensor, in accordance with further implementations. For example, referring back to FIG. 2, in accordance with further implementations, the metal layer 40 may be formed from a partially reflective metal, such as silver, for example. In this manner, the partial reflectivity of the metal layer 40 (a reflectivity of 10-80 percent, for example) forms a partial reflector for purposes of recycling the pump photons to increase the electronic enhancement provided by the quantum dot 50 and to increase the interaction cross-section of the pump with the analyte via plasmonic coupling. The resonant structure causes a build-up in the intensity of the pump in the nanostructure or on the surface of the nanostructure that further helps both the electronic and plasmonic enhancements thus further enhancing the Raman signal.

The sensor 10 may have features other than those described above to further enhance a spectral bandwidth of the Raman signal by varying the sizes and/or compositions of the nanostructures. In this manner, the electronic enhancement is, in general, a function of, or is dependent upon, the bandgap of the semiconductor and geometry of the electronically enhancing structure. Therefore, by incorporating a range of differently-sized nanostructures and/or incorporating a range of nanostructure having different compositions the spectral bandwidth of the semiconductor nanostructures can match approximately the spectral bandwidth of the Raman signal of the analyte.

For example, as depicted in FIG. 1, the diameters of the quantum dot structures 30 (i.e., the diameters of the underlying quantum dots) may vary across the surface of the substrate 20. Thus, a predetermined number of quantum dot patterns having quantum dots with randomly or pseudorandomly varying diameters may be distributed across the substrate 20. These different diameters are associated with different resonance wavelengths. Therefore, a range of diameters for the quantum dots expands the effective electronic resonance bandwidth and as such, expands the portion of the Raman bandwidth that is electronically enhanced. In further implementations, the sizes/geometries of nanostructures other than quantum dots may be varied for purposes of expanding the enhanced Raman bandwidth.

In further implementations, the compositions of the nanostructures may be varied for purposes of expanding the enhanced Raman bandwidth. For example, quantum dots have varying semiconductors and/or semiconductor structures may be spatially distributed across the surface of the substrate 20. As a more specific example, some of the quantum dots may be formed from GaAs that has an electronic resonance near an 800 nm wavelength, as blue shifted by a few or few hundred nanometers, depending on the size of the nanostructure; and other quantum dots may be formed form InP that has an electronic resonance near a 900 nm wavelength, as blue shifted by a few or few hundred nanometers, depending on the size of the nanostructure. Collectively, quantum dots having such varying compositions present an effective electronic resonance bandwidth that expands the portion of the Raman bandwidth that is electronically enhanced. In further implementations, the compositions of nanostructures other than quantum dots may be varied for purposes of expanding the enhanced Raman bandwidth.

Thus, referring to FIG. 8, in accordance with example implementations, a technique 400 includes forming (block 404) nanostructures on a substrate and depositing (block 406) a semi-transparent metal on the nanostructures to provide plasmonic enhancement and electronic enhancement to the Raman signal. The compositions of the nanostructures and/or the sizes of the nanostructures may be varied (block 408) to expand the enhanced bandwidth, pursuant to block 408.

While a limited number of examples have been disclosed herein, those skilled in the art, having the benefit of this disclosure, will appreciate numerous modifications and variations therefrom. It is intended that the appended claims cover all such modifications and variations.

What is claimed is:

1. An apparatus for surface enhanced Raman spectroscopy (SERS), the apparatus comprising:
a substrate;
a nanostructure; and
a plasmonic material,
wherein the nanostructure and the plasmonic material are integrated together to provide electronic and plasmonic enhancement to a Raman signal produced by electromagnetic radiation scattering from an analyte.

2. The apparatus of claim 1, wherein the nanostructure comprises a Group II-VI or a Group III-V semiconductor.

3. The apparatus of claim 1, wherein the plasmonic material comprises a metal selected from gold, silver, aluminum, copper, palladium, nickel and platinum.

4. The apparatus of claim 1, wherein the thickness of the plasmonic material is less than 100 nanometers.

5. The apparatus of claim 1, wherein the nanostructure comprises at least one of a quantum dot and a nanowire.

6. The apparatus of claim 1, further comprising a plurality of nanostructures including the nanostructure disposed on the substrate, wherein the sizes of the nanostructures vary across the substrate.

7. The apparatus of claim 1, further comprising a plurality of nanostructures including the nanostructure disposed on the substrate, wherein compositions of the nanostructures vary across the substrate.

8. The apparatus of claim 7, wherein the compositions comprise different semiconductor compositions.

9. The apparatus of claim 1, further comprising:
a resonator disposed on the nanostructure.

10. The apparatus of claim 9, wherein the resonator comprises at least one of a Bragg mirror and a partial reflector.

11. The apparatus of claim 10, wherein the partial reflector has a reflectivity in a range of ten to eighty percent for Raman spectra.

12. A sensor for surface enhanced Raman spectroscopy (SERS), the sensor comprising:
a substrate;
a nanostructure; and
a metal,
wherein the nanostructure and metal form an integrated structure to electronically and plasmonically enhance a Raman signal produced by electromagnetic radiation scattering from an analyte disposed in proximity to the integrated structure.

13. The sensor of claim 12, wherein the electronic resonance is a function of a band structure and geometry of the nanostructure, and the plasmonic resonance is independent of the band structure or geometry of the nanostructure.

14. The sensor of claim 12, wherein the metal has at least one of a patterning and a thickness adapted to allow the communication.

15. The sensor of claim 12, further comprising a plurality of nanostructures including the nanostructure disposed on the substrate, wherein at least the sizes or the compositions of the nanostructures vary to expand a bandwidth of the Raman signal being enhanced.

16. A method to form a sensor for enhanced Raman spectroscopy (SERS), the method comprising:
forming a nanostructure on a substrate to electronically enhance a Raman signal produced by electromagnetic radiation scattering from an analyte disposed in proximity to the metal; and
integrating the nanostructure with a material to plasmonically enhance the Raman signal.

17. The method of claim 16, wherein forming the nanostructure comprises forming at least one of a quantum dot and a nanowire on the substrate.

18. The method of claim 16, wherein the material comprises a metal, the method further comprises regulating at least one of a thickness of the metal and a patterning of the metal so that the metal allows the nanostructure to provide electronic enhancement to the Raman signal.

19. The method of claim 16, further comprising:
forming at least one of a partially reflective metal and a resonator on the nanostructure to further electronically enhance the Raman signal.

20. The method of claim 16, wherein the nanostructure comprises one of a plurality of nanostructures, the method further comprising:
regulating a bandwidth of the Raman signal being enhanced, the regulation comprising at least one of varying materials forming the nanostructures and varying sizes of the nanostructures.
